(19) United States
(12) Patent Application Publication
(10) Pub. No.: US 2026/0162116 A1
(43) Pub. Date: Jun. 11, 2026

(54) UNAUTHORIZED EVENT DETECTION USING AN APPLICATION PROGRAMMING INTERFACE (API)

(71) Applicant: Stripe, Inc., South San Francisco, CA (US)

(72) Inventors: Ryan Lee Drapeau, Seattle, WA (US); Isaac Madwed, Seattle, WA (US)

(21) Appl. No.: 18/970,697

(22) Filed: Dec. 5, 2024

(51) Int. Cl. G06Q 20/40

(52) U.S. Cl. CPC G06Q 20/4016

(57) ABSTRACT

A method and system partitioned machine learning feature generation and usage are described. The method can include a server system receiving event data generated by a platform system, the event data associated with a request. A network type associated with the request is determined, where the network type indicates a network through which the event data associated with the request are sent from the platform system to the server system. The server computer system computes feature data from a set of event data and outcome data associated with the network type, and then generates one or more prediction datasets based on the computed feature data indicative of whether the request is fraudulent.

### BACKGROUND

Service provider systems provide various services to user systems over computing networks. The services provided can include data access services, media access services, customer relationship management services, data management services, transaction services, medical services, etc., as well as a combination of such services. Modern computing techniques employed by many service provider systems typically involve deploying the functions of the service provider systems as distributed services. That is, each service may be responsible for a discrete set of functions, and the services and associated functions operate autonomously or in conjunction with one another as a whole to provide the overall functionality of a service provider system. By dividing the overall functionality of service provider systems in this way, the services may be distributed to different computing systems, multiple instances of the same services used concurrently, etc. to adapt to system load, network connectivity issues, instances of services going down, as well as other technical challenges with implementing distributed service provider systems.

In each of the above service provider systems, users of a service provider system typically interact with the service provider system via messaging over a computing network. For example, a user, via a user system, may transmit an electronic request message for one of many types of services supported by the service provider system. Then, the one or more of the services of the distributed service provider system will perform functions of the service provider system to implement the originally requested service requested by the user. For example, the service request message may be a media access service request, a telecommunications service request, a transaction processing service request, etc., and one or more services of the service provider system are invoked to process the user's request.

Prior to processing a user's request, the service provider systems may perform one or more fraud detection operations to determine whether the user's request is legitimate or fraudulent. Because each of the operations performed by the service provider system to process prior user service requests, the services of the service provider system may generate and store data associated with the requests. The service provider systems may receive and process millions, billions, or more service system requests per hour, day, week, etc., resulting in an enormous and rich scale of event data (e.g., data generated and processed by the services of the service provider system, and outcomes of the prior service system requests). Therefore, to determine whether the user's request is valid, the service provider system can invoke various machine learning (ML) models and/or rules to compute features from the event data, and use the features as input to the ML model(s). Because the service provider system has such a rich source of event data, the ML model analysis is often very accurate in determining the legitimacy of the user's requests.

Some user systems may not make service requests to the service provider system, but instead make service requests to third-party service provider systems. However, such user systems may still be interested in the fraud detection performed by the service provider system prior to issuing requests to the third-party service provider systems, due to the rich source of event data and accuracy of the ML model(s) in predicting fraudulent user requests. In this scenario, the user requests can be used to compute features for ML model analysis from the corpus of event data. However, the user system is then responsible for providing outcomes of the third-party system service processing requests (e.g., whether or not they are rejected and/or declined).

Failure to report this information and/or falsely reporting this information can result in a degradation of the service provider's fraud detection services. That is, event data without outcomes from third-party service requests may pollute event and outcome data generated by the service provider system. In other words, features computed for the event and outcome data may be incomplete and/or wrong, which reduces the accuracy of the ML model analysis for both user systems that use the service provider system as well as user systems that use third-party service provider systems. Therefore, a technical solution that avoids such data corruption, and that does not reduce accuracy of the ML model(s) analysis, is needed.

### BRIEF DESCRIPTION OF THE DRAWINGS

The present disclosure will be understood more fully from the detailed description given below and from the accompanying drawings of various embodiments, which, however, should not be taken to limit the embodiments described and illustrated herein, but are for explanation and understanding only.

FIG. 1 is a block diagram of a system architecture for a service provider system according to an embodiment.

FIG. 2 is a block diagram of a system architecture of a service provider system communicating with a platform system for partitioned feature computation.

FIG. 3 is a block diagram of a system architecture for a service provider system partitioning feature computation.

FIG. 4 is a block diagram of a system architecture for a service provider system partitioning feature computation and partitioned ML model analysis of those partitioned features.

FIG. 5 is a flow diagram of a process for a secure data event according to an embodiment.

FIG. 6 is a flow diagram of another process for a secure data event according to an embodiment.

FIG. 7 is an embodiment of a computer system that may be used to support the systems and operations discussed herein.

### DETAILED DESCRIPTION

In the following description, numerous details are set forth. It will be apparent, however, to one of ordinary skill in the art having the benefit of this disclosure, that the embodiments described herein may be practiced without these specific details. In some instances, well-known structures and devices are shown in block diagram form, rather than in detail, in order to avoid obscuring the embodiments described herein.

Some portions of the detailed description that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “receiving”, “determining”, “invoking”, “generating”, “transmitting”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The embodiments discussed herein may also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the embodiments discussed herein are not described with reference to any particular programming language. It will be appreciated that a variety of programming languages may be used to implement the teachings as described herein.

Embodiments of the disclosure are related to the partitioning of machine learning (ML) feature space to provide ML computation services, such as fraud detection services, to individual platform systems (e.g., user systems that do and do not use the service provider system for performing one or more requested services) without negatively impacting other platform system (e.g., user systems that do use the service provider system for performing a requested service). For example, a first platform system may send an API based request to a service provider system to perform a data access service, media service, etc., and the service provider system will use the request, past requests, and outcomes of the past requests to compute machine learning model features (e.g., counts of successful service requests over a period of time, counts of fraud over a period of time, whether fraud is detected on an email included with the service request, etc.). The service provider system uses the computed features to perform an ML analysis that predicts whether the service request is fraudulent prior to performing the requested services (e.g., data access, media service, etc. performed by the service provider system). A second platform system may also send an API based request with data indicative of a service to be performed by a third-party service provider system, with a request for a fraud determination to be performed based on the request data. The service provider system will compute machine learning model features similar to the discussion above to perform fraud detection, and will return a fraud result to the second platform system. Furthermore, the second platform system is responsible for reporting an outcome of the request as determined from the third-party service provider system (e.g., request approved, request declined, a reason for the decline, etc.).

In some embodiments, the reported outcome data generated by a third-party system and reported to the service provider system by the second platform system is less trusted than outcome data generated directly by the service provider system. That is, the reported outcome data may be inaccurately reported (e.g., service request approvals are reported instead of declines that were the actual outcomes of the second platform system requests), the reported outcomes may be incomplete (e.g., not all service systems request received form the second platform system have reported outcomes), or a combination thereof. For example, a second platform system may have a bug or error in its outcome reporting mechanisms, and thus one or more outcomes may have the inaccurate result (e.g., all outcomes reported as declines even though not all requests were declined by a third-party system).

Therefore, in some embodiments, request and outcome data regarding service system requests that are processed by the service provider system and those to be processed by third-party service provider systems are segregated from one another. For example, request and outcome data may be stored with an additional key, such as a key indicating whether data is associated with a service request that is processed internally by the service system or externally by a third-party service system. In some embodiments, the key may be referred to as a network key indicating the service provider system that processes the request (e.g., the network responsible for processing the requested service), and thus an inference that the outcome is a reported outcome and not one generated by the service provider system. Other keying dimensions may also be included for data, such as one or more identifiers (e.g., an email address key, a platform system key, etc.). In some embodiments, the network key is used to partition data into different data stores. In other embodiments, the network key is used to distinguish data commingled within the same data store.

In some embodiments, the service provider system can compute features from event data (e.g., past service provider system requests) and/or outcome data (e.g., results of the past service provider system requests) to detect fraudulent requests. Furthermore, due to the less trusted nature of service request data that is associated with reported outcomes (e.g., those for which fraud detection is performed, but for which a third-party service provider system actually performs the requested service), the network key can be used to limit which data is used to compute ML features. For example, a service request to be processed by a third-party system, but for which fraud detection is requested to be performed by the service provider system, the service provider system may compute ML features only from events and outcomes having the appropriate network key (e.g., a network key having a value to indicate data and outcomes were generated in response to requests and outcomes generated by their party service systems). As another example, for a service request to be processed by the service provider system, the service provider system may compute ML features only from events and outcomes having the appropriate network key (e.g., a network key having a value to indicate data and outcomes were generated by the service provider system). Thus, in the examples discussed above, even if the event and outcome data reported by the second platform system is inaccurate or incomplete, the data will not pollute or corrupt the event and outcome data generated by the service provider system directly processing service request. Furthermore, ML model analysis can still be performed for both scenarios, such as whether the service provider system or a third-party service provider system is to process a service request, and the use of the partitioned data ensures accuracy of the ML results is not diminished by corrupted or polluted data.

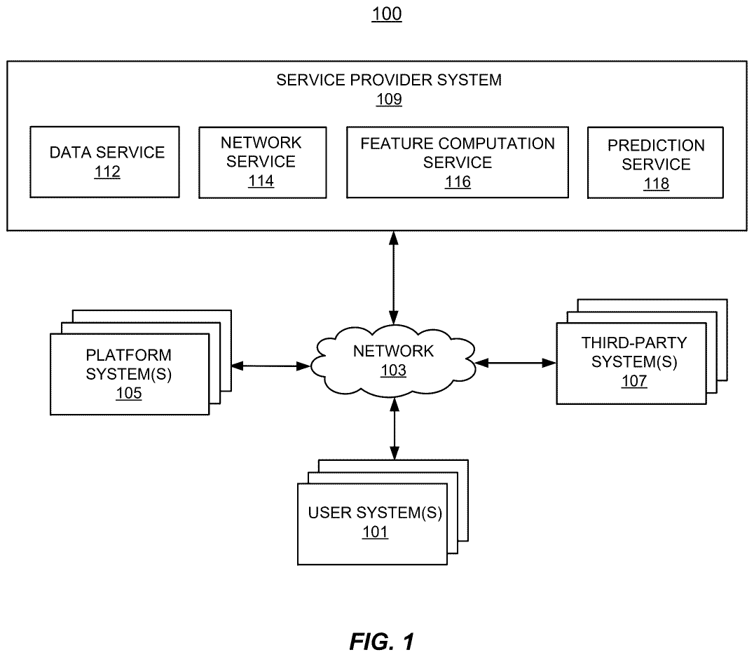

FIG. 1 is a block diagram of a system architecture for a service provider system according to an embodiment. In one embodiment, the system 100 includes a service provider system 109, one or more platform system(s) 105, one or more user system(s) 101, and one or more third-party system(s) 107 (e.g., data access systems, media management systems, gaming systems, transaction processing systems, etc.). In one embodiment, one or more systems (e.g., system 101, 105, and 107) may be computer systems, such as a desktop computer system, laptop computer system, server computer systems, etc. The service provider system 109 (e.g., a commerce platform system), platform system(s) 105 (e.g., a merchant system), and third-party system(s) 107 may also be one or more computing devices, such as one or more server computer systems, desktop computer systems, etc.

The service provider system 109, platform system(s) 105, user system(s) 101, and third-party system(s) 107 may be coupled to a network 103 and communicate with one another using any of the standard protocols for the exchange of information, including secure communication protocols. In one embodiment, one or more of the service provider system 109, platform system(s) 105, user system(s) 101, and third-party system(s) 107 may run on one Local Area Network (LAN) and may be incorporated into the same physical or logical system, or different physical or logical systems. Alternatively, the service provider system 109, platform system(s) 105, user system(s) 101, and third-party system(s) 107 may reside on different LANs, wide area networks, cellular telephone networks, etc. that may be coupled together via the Internet but separated by firewalls, routers, and/or other network devices. In one embodiment, service provider system 109 may reside on a single server, or be distributed among different servers, coupled to other devices via a public network (e.g., the Internet) or a private network (e.g., LAN). It should be noted that various other network configurations can be used including hosted configurations, distributed configurations, centralized configurations, etc.

Service provider system 109 may provide numerous services to user system(s) 101, as discussed herein. Each of these services may be carried out by one or more service system(s) of the service provider system 109. That is, service provider system 109 may divide the services it provides to end users among one or more service system(s), so that the processing of the services may be distributed among computational resources of the service provider system 109. Such distribution of service processing enables the service provider system to scale based on load, demand, hardware issues, geographic needs, expanded service offerings, as well as for other reasons.

In some embodiments, service provider system 109 may also provide event detection and prevention services (e.g., fraud detection and prevention services) for platform system(s) 105 and/or user system(s) 101. For example, as shown in FIG. 1, service provider system 109 may include, but is not limited to, a data service 112, a network service 114, a feature computation service 116, and a prediction service 118.

In some embodiments, data service 112 may be configured to receive or obtain event data, such as service requests for service to be processed by the service provider system. For example, the service provider system 109 receives event data that corresponds with a platform system 105 request of service provider system 109 to perform one or more services, and service provider system 109 generates the outcomes in response to whether or not the services are authorized to be performed. In some embodiments, data service 112 may also receive or obtain event data and outcome from platform system(s) 105, where the outcome data is generated by third-party system(s) 107 and reported to data service 112 by the platform system(s) 105.

In some embodiments, the events may be performed between a platform system 105 and a user system 101, and processed by service provider system 109 or another service provider system(s) 107. For example, user system(s) 101 may be users of platform system(s) 105, and the service provider system 109 or third-party system(s) 107 are responsible for performing the services a user system requests of a platform system. For example, a user may request a data access of a platform system, which is then carried out via data management services provided by the service provider system 109 or third-party system(s) 107. As another example, a user system may request a platform system perform a transaction on its behalf using user supplied authentication data, where the service provider system 109 or third-party system(s) 107 perform the transaction in response to authenticating the authentication data. Other service request scenarios may be used consistent with the discussion herein.

Network service 114 may extract certain attributes (e.g., a network type) from the event data and/or outcome data. The network type, as discussed herein, refers to whether service provider system 109 or third-party system(s) 107 will process a service request, and in some embodiments, such requests are received via different API endpoints or networks. In other words, network service 114 uses the attributes to determine a network through which the event data and/or outcome data are sent to the service provide system 109. In some embodiments, the network is determined by network service 114 based on an API endpoint (not shown) through which a request is received, where a first API endpoint is configured to receive service requests for services to be processed by the service provider system 109, and a second API endpoint is configured to receive service requests that seek use of the fraud detection services of the service provider system 109, and where the actual performance of the service is provided by third-party system(s) 107.

Based on the network through which the event data and/or outcome data are sent, feature computation service 116 is configured compute features for the event data and/or outcome data. In some embodiments, a network key, along with one or more other keys (e.g., user identifier key, platform system key, authentication information key, etc.), may be used by feature computation service 116 to partition the data, and thus the features, for which feature computation is performed. For example, based on the network key, feature computation service 116 may extract information or characteristics from the event data and/or outcome data to create specific features that can be used in subsequent ML models or algorithms, which such features effectively are partitioned by network type (e.g., features and outcomes associated with services processed by the service provider system 109, and features and outcomes associated with services processed by third-party system(s) 107). The computed features, for example, may include a number of times a service request (e.g., a payment) has been attempted for a particular user identifier (ID) (e.g., an email address), a number of disputes or fraudulent requests that have happened on the Internet Protocol (IP) address associated with the service request, and/or a number of successful service requests across a network (previously described) associated with the user ID. In some embodiments, the feature computation service 116 separately computes features for event data and/or outcome data sent through the networks. However, in other embodiments, feature computation service 116 may collectively compute the features for those event data and/or outcome data, for example, as a global feature computation. In doing so, feature computation service 116 may invoke trained ML model(s) (e.g., deep learning architectures such as deep neural networks, convolutional deep neural networks, deep belief networks and/or recurrent neural networks) and/or set of rule(s) (e.g., blocking rules configured to detect one or more attributes, such as stolen authentication information, a threshold number of declines, etc.) to generate features based on the event data and outcome data.

Based on the computed features (or feature data), prediction service 118 may generate one or more prediction datasets that evaluate the event. In some embodiments, the prediction datasets are sent to platform system 105 (e.g., to the API running on platform system 105) as a fraud detection result associated with a requested service that will be performed on a third-party system 107. The prediction datasets may be used to assess or predict a risk level of the event. For example, the prediction datasets may indicate whether the event is unauthorized or potentially unauthorized (e.g., a fraudulent or potentially fraudulent payment transaction). The prediction datasets may include numerous information, such as a user ID and/or an evaluation score of an event associated with the event data and/or outcome data. In some embodiments, prediction service 118 may invoke an ML model (e.g., deep learning architectures such as deep neural networks, convolutional deep neural networks, deep belief networks and/or recurrent neural networks, to generate the prediction datasets based on the computed features. In some embodiments, the ML model can include one or more ML models, such as XGBoost models, tree-based models, etc.

In the embodiments discussed above, and as will be discussed below, the addition of a network key to the event data and outcomes based upon which network a service requested (and the associated service request processing outcome) originated enables events and outcome data to be effectively partitioned. Partitioning the events and outcomes improves the data quality of the data from which fraud detection ML features are derived. More specifically, outcomes reported by platform systems for services performed at remote systems may be less reliable than outcomes generated locally by service provider system 109. The lower reliability is due to the outcomes potentially being misreported, false, due to bugs in the software executing at the platform systems, or may be absent. Thus, different data sets may be used based on which network a service request is received (e.g., a network associated with the service provider system 109 processing a service request, or a different network associated with a fraud detection request for a service to be performed by a third-party system 107). Therefore, the potentially less reliable data is prevented from polluting the higher quality data, and the ML features derived therefrom are also ensured of maximum accuracy given their respective networks. As a result, the fraud detection and the operation of the ML models used to predict fraud are improved.

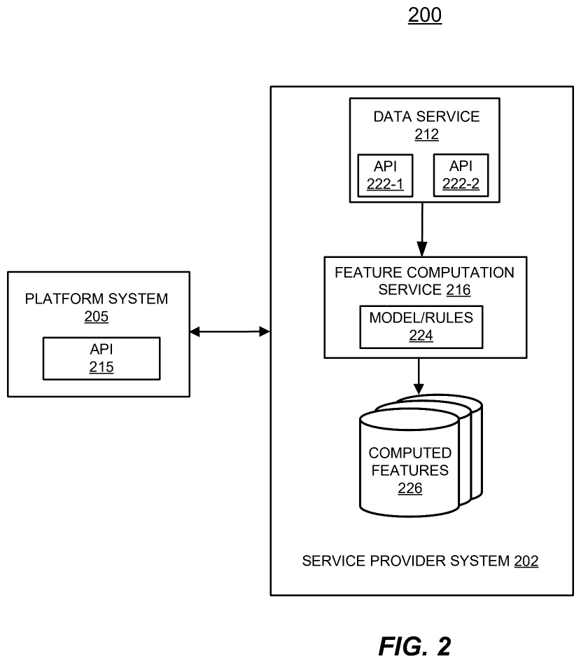

FIG. 2 is a block diagram of a system architecture of a service provider system communicating with a platform system for partitioned feature computation. In system 200 of FIG. 2, platform system 205 is in communication with service provider system 202 (e.g., over a network, such as network 103 of FIG. 1) to compute features for event data and outcome data associated with data events performed between the platform system 205 and a user system (e.g., a user system 101 of FIG. 1) associated with a user of the platform system 205. In some embodiments, platform system 205 and service provider system 202 may be a platform system 105 and service provider system 109 of FIG. 1, respectively.

With continued reference to FIG. 2, a user of platform system 205 may initiate a request (e.g., data access request, gaming service request, fraud detection request, etc.) with the platform 205 and a user system (not shown). When the request is received from the user system, in some embodiments, the platform system 205 may obtain and store event data (e.g., data associated with the request, such as one or more user or platform system identifiers, authentication data identifiers for data used to authorize the request, etc.) that is associated with the request. The platform system 205 then sends the event data as an API request from API 215 to one of API endpoint 222-1 or API endpoint 222-2. As discussed herein, the data service 212 may expose different API endpoints based on the type of service requested. API endpoint 222-1 is a first API endpoint that is configured to receive service requests for which distributed services of the service provider system 202 are requested to perform the service(s), whereas API endpoint 222-2 is a second API endpoint that is configured to receive service request event data for services which will be performed by third-party systems and for which fraud detection is requested.

For API based requests received through API endpoint 222-2, platform system 205 is also responsible for reporting outcomes of the service(s) performed by the third-party system(s), for example, through API 215. The outcome data is a result that is associated with the event data (e.g., an authorization, decline, rejection of the service request, a refund of the service request at a later date, or a dispute of the service request), and which give a full picture of how the event was handled by the third-party system.

In some embodiments, data service 212 is further responsible for storing the event and outcome data. Based on the API endpoint that initially received the request form the platform system 205, a network key value may be added to a data record for the event data. The network key, as discussed herein, identifies how the request is received and further serves to partition the event data. Thus, more reliable event and outcome data can be separately identified from the less reliable event and outcome data, as discussed herein.

Upon receiving the event data and outcome data from the platform system 205, and in some embodiments from the third-party system, the data service 212 may provide access to the collective data to the feature computation service 216 to compute features for the event data and/or outcome data. For example, feature computation service 216 may invoke an ML model (or a set of rules) 224 to extract information or characteristics from the event data and/or outcome data to create specific features (e.g., a number of times a service request has been attempted for a user ID (e.g., an email address), a number of disputes or fraudulent requests that have happened on the IP address associated with this service request, and/or a number of successful service requests across a network associated with the user ID, etc.), and store the features in the features data store 226. Feature computation service 216 may also generate numerical features, such as counts of authorization, declines, etc. associated with one or more identifiers over a set period of time. Any combination of features and feature types may be computed by feature computation service 216.

In some embodiments, feature computation service 216 further utilizes the network key associated with events and outcomes to partition the computed features. That is, given the different levels of reliability of the events and outcomes based on whether or not platform system 205 reports event outcomes, the features may be similarly computed by network key as a keying dimension to the feature so that any pollution of event/outcome data from inaccurate, false, or missing results does not also pollute computed features.

The computed features are then stored in one or more computed features data stores 226. In some embodiments, a single computed features data store is used to store all features, along with their key values. Thus, although the computed features are commingled, their associated key values may be used for prediction purposes to access the relevant features. By commingling the data records for the events and outcomes in a single set of data stores, a total number of data stores can be reduced simplifying data management.

In some embodiments, multiple computed features data stores 226 are configured to separately store the computed features partitioned by network key value. That is one or more data stores are configured to only store computed features for events and outcomes that are processed by the service provider system, whereas one or more other data stores are configured to store only computed features for events and outcomes that are processed by third-party systems. While the number of data stores is increased in these embodiments, access to and use of the data within can be made more efficient by reducing the number of data records. Furthermore, the potential for inadvertently accessing data from the incorrect network is also reduced which ensures accuracy of feature computation to reflect the network from which the data used for feature computation was performed.

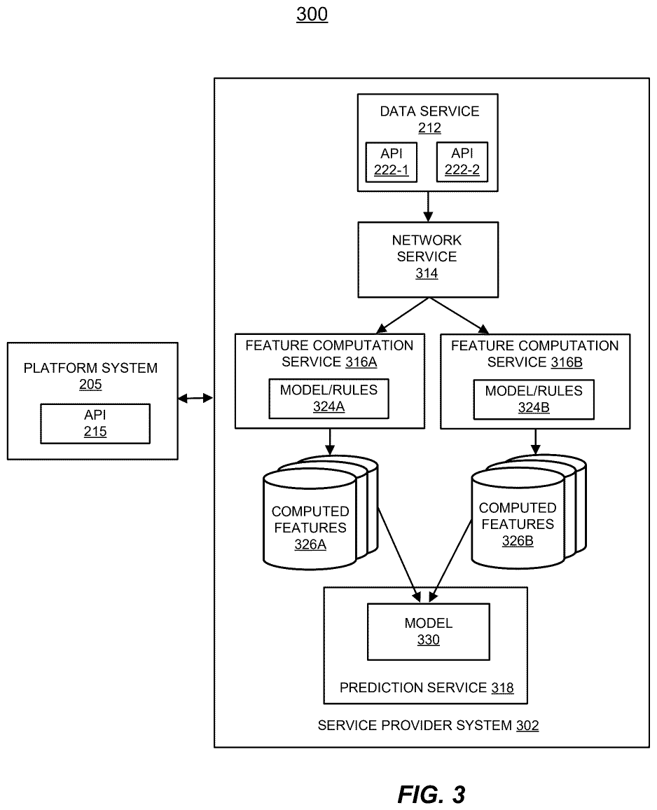

FIG. 3 is a block diagram of a system architecture for a service provider system partitioning feature computation. In FIG. 3, system 300 includes some common components with system 200 of FIG. 2 (e.g., platform system 205, API 215, data service 212, and API 222), and for brevity's sake, those common components will not be described again herein.

In system 300, platform system 205 is in communication with service provider system 302 (e.g., over a network, such as network 103 of FIG. 1) via API 215 and one of API endpoints 222-1 or 222-2. API endpoints are configured to receive service requests, and which API endpoint or network receives the request is used to set a network key value that partitions event and outcome data, as well as computed ML features, as discussed herein.

As shown, service provider system 302 may include the data service 212, a network service 314, feature computation services 316A-B, features data stores 326A-B (e.g., databases), and a prediction service 318.

In the embodiment illustrated in FIG. 3, upon receiving the event data and outcome data from the platform system 205, and in some embodiments a third-party system (not shown), via one of endpoints 222-1 or 222-2, the data service 212 may provide the collective data to the network service 314. In some embodiments, the network service 314 determines which network key to assign to the received event data and outcome data to reflect whether the service provider system 302 performs the requested service associated with the event and outcome data, or whether from the third-party system performs the requested service associated with the event and outcome data. In some embodiments, the network service 314 may extract certain attributes or information (e.g., a network type, an identifier of an API endpoint that received the service request, etc.) from the event data and/or outcome data. Based on the extracted attributes, the value of the network key for the event and outcome data can be set.

Based on the determination of the network described above, network service 314 may respectively provide the event data and the outcome data received through the network to feature computation services 316A or 316B. In an embodiment, feature computation service 316A or 316B may compute features for the event data and the outcome data received through the first network based on a user ID (e.g., an email address of a user of platform system 205), a network key value indicating the specific network, an identifier of the platform system 205, as well as other identifiers. Furthermore, the features computed by feature computation services 316A and 316B use the identifiers to access a corpus of service request event and outcome data for past service requests. Therefore, for the received request's event and/or outcome data, a history of event and outcome data, having the same network key value, can be accessed to compute a variety of features. As an example, the feature computation service 316A or 316B may respectively invoke an ML model (or a set of rules) 324A or 324B to extract or compute information or characteristics from the event data and outcome data, filtered by one or more IDs, the network key value, the identifier of the platform system 205, as well as other feature keying values, to create specific features (e.g., numerical features, categorical features, ordinal features, binary features, text features, etc.), and store the features in the features data store 326A.

The features, as discussed herein, can include count-based features (e.g., number of rejected service requests for a given combination of user, platform system, and network type).

The features, in some embodiments, may also be ML model derived features. The ML models 324A, 324B may be trained to identify and extract relevant features from the raw event data and outcome data that are compatible with a subsequent ML model or set of rules (e.g., ML model 330, which will be described in more detail herein below). In some embodiments, the ML models 324A, 324B can be deep learning architectures such as deep neural networks, convolutional deep neural networks, deep belief networks and/or recurrent neural networks. In some embodiments, ML models 324A, 324B can include any suitable ML models, such as XGBoost models, tree-based models, etc.

The features, in some embodiments, may also be rule based features. The rules, for example, can generate a feature upon detecting a certain condition or characteristic associated with a service request or data accessed to compute features. For example, a service request may include data indicative of origination in a certain geographic region. In some embodiments, certain geographic regions can be associated with fraud, and a feature created or set to indicate the service request originated from such a region. As another example, a rule may indicate that a certain number of service request rejections can indicate fraudulent intent by a platform system or user system. Thus, detecting satisfaction of a threshold value of a certain characteristic can set a feature value.

In embodiments, feature computation service 316A and 316A are themselves partitioned to improve the ML and rules feature computations performed by each service. That is, the ML models are trained to generate features for a given network type, and may therefore develop and respond to how features are generated for the different network types. Furthermore, in some embodiments, features may be computed differently based on network type to account or factor for the different levels of trust. Therefore, in the embodiment of FIG. 3, feature computation can be partitioned to improve the derivation of features from received event and/or outcome data.

Using the computed features from features data stores 326A, 326B, prediction service 318 may generate one or more prediction datasets that evaluate the data event for the current service request. In some embodiments, prediction service 318 executes one or more ML models trained to detect fraudulent service requests from the features generated from event and outcome data. That is, the ML models can be trained to perform an analysis to determine a recommendation as to what to do with the current service request. The set of actions the models can recommend may include allow, block, and/or intervene due to medium risk. In some embodiments, the recommended action is the result of comparing ML predictions against certain thresholds to determine the best action. In some embodiments, the prediction service 318 (or ML models) may invoke rules that leverage the predictions. For example, if the ML models determine that an IP address is risky but the current service request is not risky, the models can recommend the intervene action instead of the block action. The ML models, in embodiments, can include one or more ML models, such as neural network, support vector machines, XGBoost models, decision tree-based models, etc., as well as an ensemble of models. In some embodiments, the prediction service 318 may alternatively, or in combination with the ML models discussed above, execute one or more rules that detection conditions associated with a generated feature.

In some embodiments, prediction service 318 will transmit the prediction datasets (e.g., fraud detection evaluation results) back to platform system 205 (e.g., via API 215 running on platform system 205), where the network key indicates that a third-party system will perform the requested service. In some embodiments, prediction service 318 will transmit prediction data sets to one or more of the distributed service systems (not shown) of the service provider system. The platform system 205 or downstream distributed service systems of the service provider system 302 may use the prediction data set to determine whether or not to proceed with a service request.

The prediction datasets, as discussed herein, may be used to assess or predict a risk level of the event. For example, the prediction datasets may indicate whether the event is unauthorized or potentially unauthorized (e.g., a fraudulent or potentially fraudulent payment transaction). Each prediction dataset may include an evaluation or risk score generated from event and outcome data for a requested service. In some embodiments, prediction service 318 invokes an ML model 330 (e.g., a deep learning architecture such as a deep neural network, convolutional deep neural network, deep belief network and/or recurrent neural network, or a combination of ML models) to generate the prediction datasets based on the computed features in data stores 326A and/or 326B. In some embodiments, the ML model 330 may be trained to identify and predict anomalies (e.g., fraudulent patterns) using historical and current computed features from one or both of the networks (e.g., computed features stored in data stores 326A and/or 326B), and generate prediction datasets associated with the prediction.

In some embodiments, the feature computation space is partitioned into feature computation service 316A and feature computation service 316B. The partitioning effectively white-labels the feature computation and risk detection so that platform system 205 can access the risk analysis provided by service provider system, even if the platform system 205 will not use the service provider system 302 to perform a requested service. This improves the flexibility of fraud detection services that can be provided by service provider system 302 to platform systems, such as platform system 205. Furthermore, as discussed above, the events and outcomes are partitioned according to the network from which they were received. Then, the partitioned data sources can further be used by partitioned ML feature computation services in system 300. Thus, not only is data corruption and pollution reduced or eliminated through the partitioning of the data sources by network key, but the feature computation partitioning further ensures that the features derived from the partitioned event data and the outcome data are not shared across boundaries. Such separation ensures integrity of the analysis performed by prediction service 318.

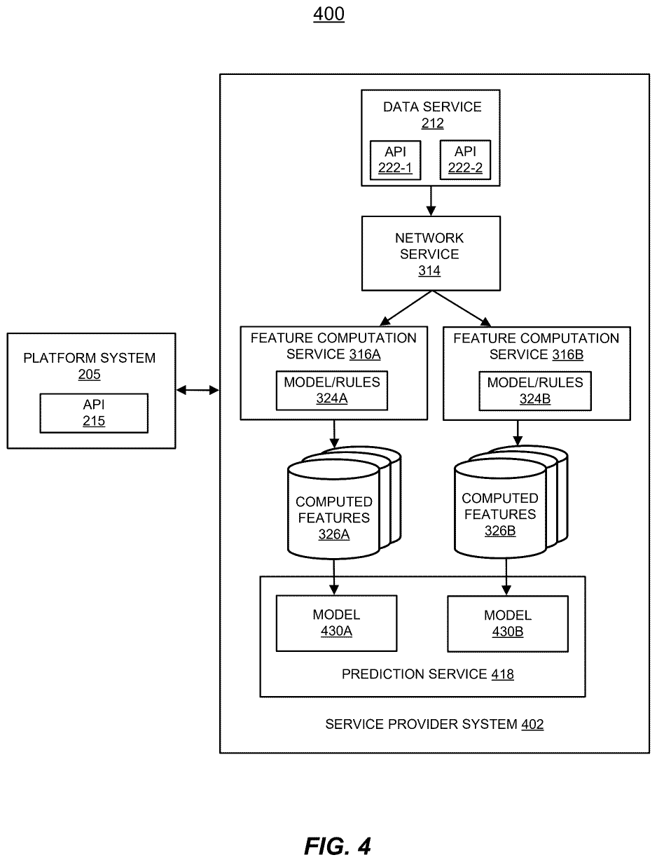

FIG. 4 is a block diagram of a system architecture for a service provider system communicating with a platform system according to an embodiment. In FIG. 4, system 400 includes some common components with system 300 of FIG. 3 (e.g., platform system 205, API 215, data service 212, API 222, network service 314, feature computation services 316A-B, model/rules 324A-B, and data stores 326A-B), and for brevity's sake, those common components will not be described again herein.

In FIG. 4, features are computed, partitioned, and stored in data stores 326A-B as discussed in FIG. 3. However, in some embodiments of FIG. 4, the partitioned features in data stores 326A-B respectively provide input to ML models 430A-B of prediction service 418 based on a network associated with a received request, such as a network through which the request will be processed by a service provider system or a network through which the request will be processed by a third-party system. That is, in some embodiments, the partition between network types is carried through the feature computation, feature storage, and ML model analysis stages. Such partitioning further strengthens the data separation between network types and ensures that data pollution cannot spread across the imposed segmentation boundaries.

In this embodiment, prediction service 418 may invoke respective ML models 430A, 430B (e.g., a deep learning architecture such as a deep neural network, convolutional deep neural network, deep belief network, recurrent neural network, a support vector machine, a decision tree based model, or a combination of ML models) to generate respective prediction datasets based on the computed features in data stores 326A, 326B. In some embodiments, the prediction datasets generated by each of models 430A and 430B may be combined, for example as an average, a weighted average that favors the more trusted partition, a ratio, or other combination. By combining results, some inaccuracies and data gaps may be improved by the prediction datasets generated by the more trusted partition. In other embodiments, a prediction data set is only generated by the partition associated with the network type through which a service request is received. For example, if a service request is to be processed by a third-party system, only feature computation results from that partition and ML model analysis from that partition are used.

Furthermore, in embodiments, having model 430A and 430B partitioned to different network types includes training the models with training data associated with the different network types. Thus, in the embodiment of FIG. 4, the models may adapt to different fraud patterns of each type of network. That is, for example, fraud patterns in service requests that are handled by the service provider system 402 may be different from the fraud patterns in service requests that are handled by third-party systems. Having the models be portioned and trained separately enables the models to adapt to their respective and different fraud patterns over time so that each model more accurately predicts fraud for a given network type through which a service request is received.

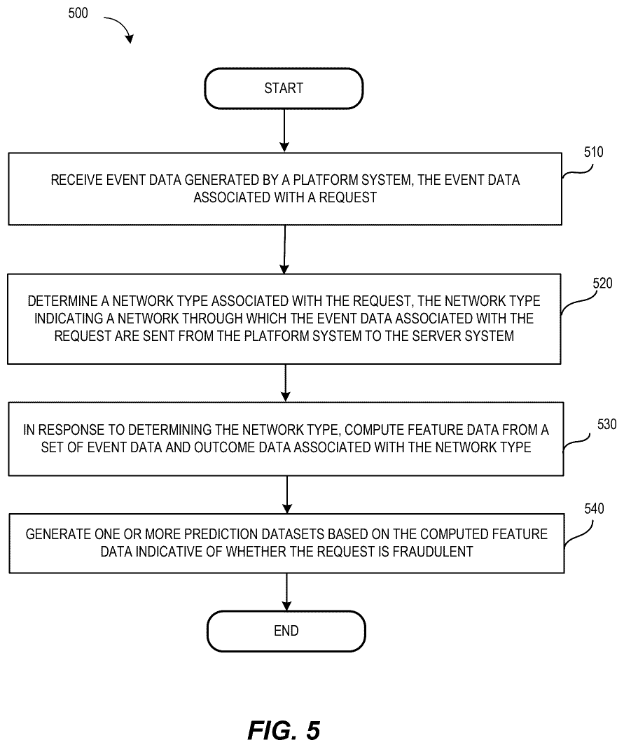

FIG. 5 is a flow diagram of a process for a secure data event according to an embodiment. Method 500 may be performed by processing logic that may comprise hardware (circuitry, dedicated logic, etc.), software (such as is run on a general purpose computer system or a dedicated machine), firmware, or a combination. In one embodiment, the method 500 is performed by service provider system 302 of FIG. 3 (e.g., data service 212, network service 314, feature computation services 316A-B, and prediction service 318), or a server system hosting the service provider system 302.

Referring to FIG. 5, at block 510, the processing logic receives event data generated by a platform system, the event data associated with a request. The request is a service system request and the event data includes a combination of one or more user identifiers, one or more platform system identifiers, a type of service requested, etc. associated with the service system request.

At block 520, the processing logic determines a network type associated with the request, the network type indicating a network through which the event data associated with the request are sent from the platform system to the server system. The network type may indicate a network through which the event data associated with the service request is sent. For example, the network type can refer to different network types, such as a network type that corresponds to an API endpoint that received the event data. In embodiments, the different network types correspond to a network through which service requests are received that the server computer system is requested to process, and a different network through which other service requests are received that a third-party system will be responsible for processing and for which a prediction dataset is requested.

At block 530, in response to determining the network type, processing logic computes feature data from a set of event data and outcome data associated with the network type. In some embodiments, event data and outcome data are partitioned, where such partitioning may be accomplished through a network key value being set of each event data and outcome data. The network key defines the network type, and features are computed from event and outcome data belonging to the same network type. As discussed herein, the network types may generate data associated with different levels of trust. Thus, by computing features based on network type, the computed features are also associated with that level of trust. Furthermore, if a lower level of trusted data is not accurate or incomplete, the use of the network key to store, identify, and compute features reduces or eliminates the potential for data pollution between partitions.

At block 540, processing logic generates one or more prediction datasets based on the computed feature data indicative of whether the request is fraudulent. In some embodiments, the computed feature data are input into one or more machine learning models that are executed by processing logic. The machine learning model(s) are trained to detect fraud associated with service request, such as the request received at block 510, based on the event data and a corpus of event and outcome data from previous service request that are of the same network type. Thus, the machine learning model generates the prediction dataset based on the features generated from the data and outcomes partitioned by network type. As a result, any data pollution or accuracy loss is limited to service requests received over a network type where a third-party processes the network request, and a platform system is responsible for accurately responding with the service request outcomes.

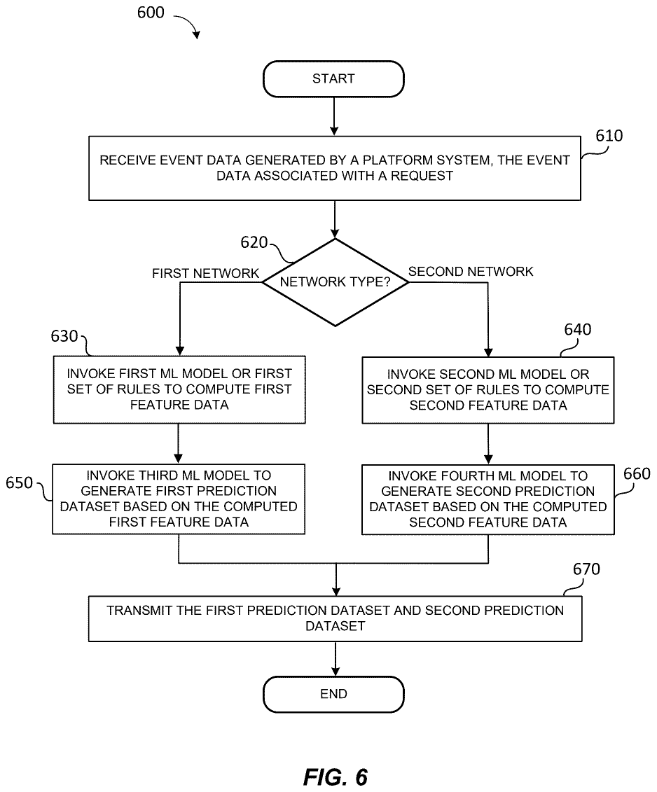

FIG. 6 is a flow diagram of another process for a secure data event according to an embodiment. Method 600 may be performed by processing logic that may comprise hardware (circuitry, dedicated logic, etc.), software (such as is run on a general purpose computer system or a dedicated machine), firmware, or a combination. In one embodiment, the method 600 is performed by service provider system 402 of FIG. 4 (e.g., data service 212, network service 314, feature computation services 316A-B, and prediction service 418), or a server system hosting the service provider system 402.

Referring to FIG. 6, at block 610, the processing logic receives event data generated by a platform system, the event data associated with a request. As discussed above, the request is a service system request and the event data includes a combination of one or more user identifiers, one or more platform system identifiers, a type of service requested, etc. associated with the service system request.

At block 620, the processing logic may determine a network type associated with the received event data and/or outcome data. The network type may indicate a network through which the event data event data associated with the service request is received. In some embodiments, the network type is determined by processing logic based on an API endpoint through which the event data was received.

At block 630, if it is determined that the network type indicates a first network, such as a network where the service provider system is to process the requested service, the processing logic may invoke a first ML model or a first set of rules to compute first feature data from the event data and/or outcome data. Furthermore, the first feature data may be computed based on the first network type. In some embodiments, requests and event data received through the first network type are associated with a higher level of trust, since associated outcome data is also generated by the service provider system. The higher level of trust is assigned because the processing logic knows that the outcome data is complete, accurate, and any event data will have an associated outcome data after the service is processed by the service provider system.

At block 640, if it is determined that the network type indicates a second network, such as a network where a third-party system is to process the requested service, the processing logic may invoke a second ML model or a second set of rules to compute second feature data from the event data and/or outcome data. The second feature data is computed based on the second network type. The second network type, in comparison to the first network type, is associated with service requests where a third-party processes the service, and a platform system is responsible for reporting a service processing result (e.g., approved, declined, rejected, etc.) of the third-party system. Because a reporting is required, risk is introduced into the reporting's accuracy and completeness. Thus, the second features computed based on the second network type are also considered of lower quality, but still relevant to prediction performance.

At block 650, the processing logic may invoke a third ML model to generate a first prediction dataset based on the computed first feature data. The third ML model is a model trained prediction datasets specifically for the first network. As a result, the third ML model may be trained and adapt over time to the fraud patterns and attack vectors experienced by service requests sent over the first network. Furthermore, as discussed herein, the prediction dataset is a prediction or likelihood that the service request is fraudulent.

At block 660, the processing logic may invoke a fourth ML model to generate a second prediction dataset based on the computed second feature data. The second prediction dataset, similar to the discussion herein, is a prediction or likelihood that the service request is fraudulent. The fourth ML model is a model trained prediction datasets specifically for the second network. Because of the lower trust in the data sources of the second network, and the likelihood that different types of service request, different patterns of service requests, etc. are associated with the second network type, the fourth ML model may be trained and adapt over time to the different fraud patterns and attack vectors experienced by service requests processed by third-party systems.

In some embodiments, as illustrated and discussed with respect to processing blocks 620-660, after network type is determined, both ML feature computation and ML model analysis for prediction dataset generation are partitioned to ensure data corruption cannot cross the partition lines. Furthermore, the partitioning enhances the ML operations, as discussed herein, because feature generate and feature analysis by the respective ML models adapts to the patterns of their respective networks.

At block 670, the processing logic may transmit the first prediction dataset and the second prediction dataset. In some embodiments, separate prediction datasets are transmitted. In other embodiments, the prediction data sets can be combined, such as through averaging, weighted averaging, or other function to combine the predictions. In some embodiments, based on network type, the predictions are either transmitted back to the platform system (e.g., when a third-party system is to process the service request, and the platform system uses the prediction dataset to determine whether to forward the service request to the third-party system), or to one or more downstream distributed service systems of the service provider system.

In methods 500 and 600, and as discussed in greater detail herein, by partitioning the ML feature computations and/or ML analysis to separate networks, data corruption and pollution can be reduced or eliminated as the event data and the outcome data received through the first and second networks are not shared across the partition boundary. Furthermore, the ML computation service that generates prediction datasets (e.g., fraud detection predictions) can be white-labelled and offered to individual platform systems that do not use the service provider system for actually processing a service request, but which desire to use the enhanced fraud detection capabilities of the service provider system. The white-labelled fraud detection according to the embodiments discussed herein, which involves relying on platform systems to report outcomes and thus is inherently less reliable, can be perform without causing impact to users of a service provider system or the network of the service provider system.

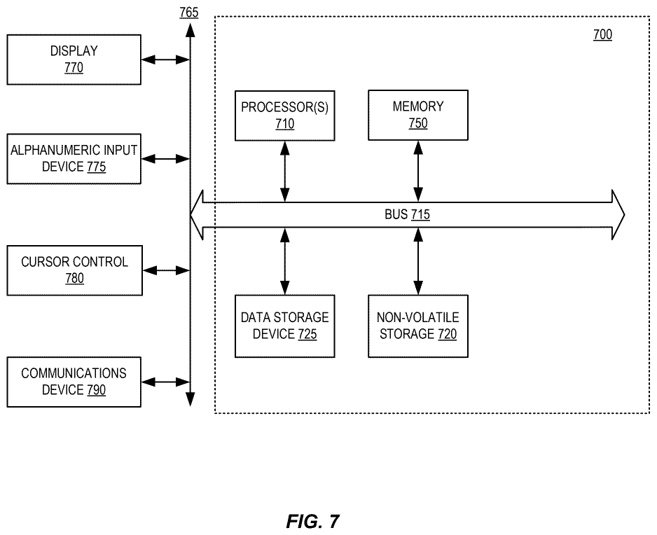

FIG. 7 is an embodiment of a computer system that may be used to support the systems and operations discussed herein. The data processing system illustrated in FIG. 7 includes a bus or other internal communication means 715 for communicating information, and one or more processors 710 coupled to the bus 715 for processing information. The system further comprises a random access memory (RAM) or other volatile storage device 750 (referred to as memory), coupled to bus 715 for storing information and instructions to be executed by processor(s) 710. Main memory 750 also may be used for storing temporary variables or other intermediate information during execution of instructions by processor(s) 710. The system also comprises a read only memory (ROM) and/or static storage device 720 coupled to bus 715 for storing static information and instructions for processor(s) 710, and a data storage device 725 such as a magnetic disk or optical disk and its corresponding disk drive. Data storage device 725 is coupled to bus 715 for storing information and instructions.

The system may further be coupled to a display device 770, such as a light emitting diode (LED) display or a liquid crystal display (LCD) coupled to bus 715 through bus 765 for displaying information to a computer user. An alphanumeric input device 775, including alphanumeric and other keys, may also be coupled to bus 715 through bus 765 for communicating information and command selections to processor(s) 710. An additional user input device is cursor control device 780, such as a touchpad, mouse, a trackball, stylus, or cursor direction keys coupled to bus 715 through bus 765 for communicating direction information and command selections to processor(s) 710, and for controlling cursor movement on display device 770.

Another device, which may optionally be coupled to computer system 700, is a communication device 790 for accessing other nodes of a distributed system via a network. The communication device 790 may include any of a number of commercially available networking peripheral devices such as those used for coupling to an Ethernet, token ring, Internet, or wide area network. The communication device 790 may further be a null-modem connection, or any other mechanism that provides connectivity between the computer system 700 and the outside world. Note that any or all of the components of this system illustrated in FIG. 7 and associated hardware may be used in various embodiments as discussed herein.

It will be appreciated by those of ordinary skill in the art that any configuration of the system may be used for various purposes according to the particular implementation. The control logic or software implementing the described embodiments can be stored in main memory 750, mass storage device 725, or other storage medium locally or remotely accessible to processor 710.

It will be apparent to those of ordinary skill in the art that the system, method, and process described herein can be implemented as software stored in main memory 750 or read-only memory 720 and executed by processor(s) 710. This control logic or software may also be resident on an article of manufacture comprising a computer readable medium having computer readable program code embodied therein and being readable by the mass storage device 725 and for causing the processor(s) 710 to operate in accordance with the methods and teachings herein.

The embodiments discussed herein may also be embodied in a handheld or portable device containing a subset of the computer hardware components described above. For example, the handheld device may be configured to contain only the bus 715, the processor(s) 710, and memory 750 and/or 725. The handheld device may also be configured to include a set of buttons or input signaling components with which a user may select from a set of available options. The handheld device may also be configured to include an output apparatus such as a liquid crystal display (LCD) or display element matrix for displaying information to a user of the handheld device. Conventional methods may be used to implement such a handheld device. The implementation of embodiments for such a device would be apparent to one of ordinary skill in the art given the disclosure as provided herein.

The embodiments discussed herein may also be embodied in a special purpose appliance including a subset of the computer hardware components described above. For example, the appliance may include processor(s) 710, a data storage device 725, a bus 715, and memory 750, and only rudimentary communications mechanisms, such as a small touch-screen that permits the user to communicate in a basic manner with the device. In general, the more special-purpose the device is, the fewer of the elements need be present for the device to function.

It is to be understood that the above description is intended to be illustrative, and not restrictive. Many other embodiments will be apparent to those of skill in the art upon reading and understanding the above description. The scope should, therefore, be determined with reference to the appended claims, along with the full scope of equivalents to which such claims are entitled.

The foregoing description, for purpose of explanation, has been described with reference to specific embodiments. However, the illustrative discussions above are not intended to be exhaustive or to limit the described embodiments to the precise forms disclosed. Many modifications and variations are possible in view of the above teachings. The embodiments were chosen and described in order to best explain the principles and practical applications of the various embodiments, to thereby enable others skilled in the art to best utilize the various embodiments with various modifications as may be suited to the particular use contemplated.

What is claimed is:

1. A computer-implemented method, comprising:
receiving, by a server system, event data generated by a platform system, the event data associated with a request;
determining, by the server system, a network type associated with the request, the network type indicating a network through which the event data associated with the request are sent from the platform system to the server system;
in response to determining the network type, computing, by the server computer system, feature data from a set of event data and outcome data associated with the network type;
generating, by the server system, one or more prediction datasets based on the computed feature data indicative of whether the request is fraudulent.

2. The method of claim 1, wherein the request comprises a request to perform a service, and the network type is determined based on whether the server computer system or a third-party system is to perform the service.

3. The method of claim 2, wherein the server computer system is to perform the service when the event data is transmitted in a first API message received through a first API endpoint of the server system, and the third-party system is to perform the service when the event data is transmitted in a second API message received through a second API endpoint of the server system.

4. The method of claim 1, further comprises:
storing, by the server system in a data store, the event data with a network key indicative of the determined network type;
receiving, by the server system from the platform system, outcome data associated with a result of a third-party system processing the request; and
storing the outcome data with the network key indicative of the determined network type.

5. The method of claim 4, wherein the outcome data comprises an indication that the request was rejected by the third-party system or accepted by the third-party system.

6. The method of claim 1, further comprising:
transmitting, by the server system, the one or more prediction datasets to the platform system when the network type indicates a first network; and
transmitting, by the server system, the one or more prediction datasets to service processing system of the server system when the network type indicates a second network.

7. The method of claim 1, wherein computing the feature data comprises:
in response to determining that the network type indicates a first network, invoking, by the server system, a first machine learning (ML) model or a first set of rules to compute first feature data for the event data from a set of event data and outcome data associated with the event data and having the same network type; and
in response to determining that the network type indicates a second network, invoking, by the server system, a second ML model or a second set of rules to compute second feature data for the event data from the set of event data and outcome data associated with the event data and having the same network type.

8. The method of claim 7, wherein generating the one or more prediction datasets comprises:
invoking, by the server system, a third ML model to generate a prediction dataset based on the computed first feature data and the computed second feature data.

9. The method of claim 7, wherein generating the one or more prediction datasets comprises:
invoking, by the server system, a third ML model to generate a first prediction dataset based on the computed first feature data;
invoking, by the server system, a fourth ML model to generate a second prediction dataset based on the computed second feature data; and
combining, by the server system, the first prediction dataset and the second prediction dataset into a final prediction dataset.

10. One or more non-transitory computer readable storage media having instructions stored thereupon which, when executed by a server system having at least a processor and a memory therein, cause the server system to perform operations, the operations comprising:
receiving, by the server system, event data generated by a platform system, the event data associated with a request;
determining, by the server system, a network type associated with the request, the network type indicating a network through which the event data associated with the request are sent from the platform system to the server system;
in response to determining the network type, computing, by the server computer system, feature data from a set of event data and outcome data associated with the network type;
generating, by the server system, one or more prediction datasets based on the computed feature data indicative of whether the request is fraudulent.

11. The non-transitory computer readable storage media of claim 10, wherein the request comprises a request to perform a service, and the network type is determined based on whether the server computer system or a third-party system is to perform the service.

12. The non-transitory computer readable storage media of claim 11, wherein the server computer system is to perform the service when the event data is transmitted in a first API message received through a first API endpoint of the server system, and the third-party system is to perform the service when the event data is transmitted in a second API message received through a second API endpoint of the server system.

13. The non-transitory computer readable storage media of claim 10, wherein the operations further comprise:
storing, by the server system in a data store, the event data with a network key indicative of the determined network type;
receiving, by the server system from the platform system, outcome data associated with a result of a third-party system processing the request; and
storing the outcome data with the network key indicative of the determined network type.

14. The non-transitory computer readable storage media of claim 10, wherein the operations further comprise:
transmitting, by the server system, the one or more prediction datasets to the platform system when the network type indicates a first network; and
transmitting, by the server system, the one or more prediction datasets to service processing system of the server system when the network type indicates a second network.

15. The non-transitory computer readable storage media of claim 10, wherein the operations further comprise:
in response to determining that the network type indicates a first network, invoking, by the server system, a first machine learning (ML) model or a first set of rules to compute first feature data for the event data from a set of event data and outcome data associated with the event data and having the same network type; and
in response to determining that the network type indicates a second network, invoking, by the server system, a second ML model or a second set of rules to compute second feature data for the event data from the set of event data and outcome data associated with the event data and having the same network type.

16. A server system, comprising:
a memory; and
a processor coupled with the memory configured to perform operations comprising:
receiving, by the server system, event data generated by a platform system, the event data associated with a request;
determining, by the server system, a network type associated with the request, the network type indicating a network through which the event data associated with the request are sent from the platform system to the server system;
in response to determining the network type, computing, by the server computer system, feature data from a set of event data and outcome data associated with the network type; and
generating, by the server system, one or more prediction datasets based on the computed feature data indicative of whether the request is fraudulent.

17. The server system of claim 16, wherein the request comprises a request to perform a service, and the network type is determined based on whether the server computer system or a third-party system is to perform the service.

18. The server system of claim 16, wherein the server computer system is to perform the service when the event data is transmitted in a first API message received through a first API endpoint of the server system, and the third-party system is to perform the service when the event data is transmitted in a second API message received through a second API endpoint of the server system.

19. The server system of claim 16, wherein the operations further comprise:
storing, by the server system in a data store, the event data with a network key indicative of the determined network type;
receiving, by the server system from the platform system, outcome data associated with a result of a third-party system processing the request; and
storing the outcome data with the network key indicative of the determined network type.

20. The server system of claim 16, wherein the operations further comprise:
transmitting, by the server system, the one or more prediction datasets to the platform system when the network type indicates a first network; and
transmitting, by the server system, the one or more prediction datasets to service processing system of the server system when the network type indicates a second network.
